(19) United States
(12) Patent Application Publication
(10) Pub. No.: US 2006/0182442 A1
(43) Pub. Date: Aug. 17, 2006

(54) Optical module and electronic device

(75) Inventor: Kimio Nagasaka, Nirasaki-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/340,764

(22) Filed: Jan. 27, 2006

(30) Foreign Application Priority Data
Feb. 15, 2005 (JP) 2005-037207

(51) Int. Cl. H04B 10/24

(52) U.S. Cl. 398/41

(57) ABSTRACT

An optical module that is attachable to one end of an optical transmission medium achieves optical communications through the optical transmission medium. The optical module includes an optical element that transmits or receives an optical signal, and an optical block that is disposed in a transmission path of the optical signal and couples the optical axes of the optical element, wherein the optical block has an inclined surface the normal of which forms an angle with respect to the optical axis of the optical transmission medium, the angle being in a range of greater than 0 degree to less than 90 degree or in the range of greater than 90 degree to less than 180 degree.

The entire disclosure of Japanese Patent Application No. 2005-037207, filed Feb. 15, 2005 is expressly incorporated by reference herein.

### BACKGROUND

1. Technical Field

The present invention relates to optical modules that may be used for data communications using light.

2. Related Art

Japanese Laid-open Patent Application JP-A-2004-246279 describes an optical module that uses a structure for achieving an optical coupling by changing a traveling path of an optical signal outputted from one end of an optical transmission medium or an optical signal emitted from an optical element through about 90 degrees.

In the optical module described above, an interface at which different media (for example, plastic material and air) are in contact with each other may often exist in an optical path of optical signals. In this case, when an optical signal is incident upon the interface between the two different media at an angle orthogonal or near orthogonal to the interface, a part of the optical signal reflects, which becomes to be returning light. If the returning light enters a resonator section, such as, a VCSEL of the light emitting element, the operation of the light emitting element becomes unstable, which causes changes in the emission power, and generates noise. Also, if the returning light enters one end of the optical transmission medium, the returning light is transmitted to the other end of the optical transmission medium and enters the light emitting element at the other end, which causes similar problems as described above.

### SUMMARY

In accordance with an advantage of some aspects of the invention, an optical module can reduce noise that is caused by returning light.

In accordance with an embodiment of the invention, there is provided an optical module that may be attached to one end of an optical transmission medium to achieve optical communications through the optical transmission medium, the optical module including an optical element that transmits or receives an optical signal, and an optical block that is present between the optical element and the optical transmission medium for coupling optical axes thereof, wherein the optical block has an inclined surface angled with respect to the optical axis of the optical transmission medium, and is disposed in a state in which a gap is generated between the inclined surface and the optical transmission medium, and the optical element is disposed in a manner to receive the optical signal that enters from the optical transmission medium and is reflected at the inclined surface, or to cause the optical signal transmitted to be reflected at the inclined surface and then enter the optical transmission medium.

According to the structure described above, an optical coupling between the optical transmission medium and the optical element is made through the inclined surface that is placed in a state not being orthogonal to a principal ray of the optical signal, such that, even when returning light (reflected wave component) is generated at the inclined surface, the returning light propagates in a direction different from the direction of the principal ray of the optical signal. Accordingly, an incidence of the returning light upon the optical element or the optical transmission medium can be avoided, and noise that may be caused by the returning light can be reduced.

Preferably, the optical module is further equipped with a first lens that changes the optical signal outputted from the optical transmission medium into generally parallel light, or focuses the optical signal outputted from the inclined surface at one end of the optical transmission medium, and a second lens that changes the optical signal emitted from the optical element into generally parallel light, or focuses the optical signal advancing toward the optical element at a predetermined position of the optical element.

By the above, the light signal that is placed in a state of being generally parallel light can be made incident upon the inclined surface. Accordingly, most components of the returning light from the inclined surface advance in a predetermined direction, such that designing of the inclination angle of the inclined surface becomes easier.

Preferably, the optical element is disposed on the underside of the optical block in a state in which the optical axis of the optical element is generally orthogonal to the optical axis of the optical transmission medium, and the optical block may be further equipped with a reflection surface that changes the course of the optical signal that is outputted from the optical transmission medium and reflected at the inclined surface toward the optical element, or reflects the optical signal transmitted from the optical element toward the inclined surface.

According to the above, a returning light prevention structure in accordance with the present embodiment can be implemented in an optical module that is made thinner by using an arrangement in which the optical axis of the optical transmission medium and the optical axis of the optical element are placed generally orthogonal to each other. Also, even when the inclination angle of the inclined surface is relatively small and the angle of reflection of the returning light is small, an incidence of a part of the returning light upon the optical element or the optical transmission medium can be more securely avoided as the optical axis of the optical transmission medium and the optical axis of the optical element are generally orthogonal to each other.

Also, when the optical block is equipped with the reflection surface as described above, the inclined surface of the optical block may preferably be disposed to be angled in a direction that refracts an optical signal entering from the optical transmission medium to an upper side of the optical block.

When an optical block is formed by an injection molding method or the like, it is desired to keep the distance between the upper side (the side where the reflection surface is provided) of the optical block and the lower side of the optical block, in other words, the distance in a thickness direction of the optical block as great as possible. On the other hand, from the viewpoint of forming the optical module thinner, the position of an optical coupling point with the optical transmission medium (the position where the inclined surface is provided in the present embodiment) may preferably be closer to the lower side of the optical block as much as possible. By arranging the inclined surface in the manner described above, these demands can both be met, and the thickness of the optical block can be made smaller while maintaining the forming accuracy.

Preferably, the angle defined between the inclined surface and the optical axis of the optical transmission medium is set to about 15°-30°.

By this, influence by the polarization dependency of transmittance characteristics of light at the inclined surface can be reduced.

Also, when one end of the optical transmission medium is supported by a plug, the inclined surface may preferably be disposed such that at least a portion of the inclined surface contacts a tip section of the plug.

By this, the inclined surface may also be used as a positioning device, whereby the structure may be simplified.

A second embodiment of the invention pertains to an electronic device provided with the optical module described above. It is noted here that the “electronic device” refers to devices in general that realize specified functions using electronic circuits or the like, and is not particularly limited to a specific structure, and may include a variety of devices, such as, for example, personal computers, PDAs (potable data terminals), electronic notebooks and the like. The optical module in accordance with the present invention can be used in these electronic devices for data communications within the devices or with external devices and the like.

### BRIEF DESCRIPTION OF THE DRAWINGS

FIG. 1 is a perspective view schematically showing a structure of an optical module in accordance with an embodiment of the invention.

FIG. 2 is an exploded perspective view of the optical module shown in FIG. 1.

FIG. 3 is a cross-sectional view of the optical module shown in FIG. 1 taken along a line III-III.

FIG. 4 is a diagram for describing a method of analytically obtaining inclinations of a reflection surface and an inclined surface.

FIG. 5 is a graph for describing a preferred example of conditions for setting an inclination of the inclined surface.

FIG. 6 is a diagram for describing a method of analytically obtaining an inclination of an inclined surface of an optical module having another exemplary structure.

FIG. 7 is a perspective view showing a structure of an example of an electronic apparatus.

### DESCRIPTION OF EXEMPLARY EMBODIMENTS

Embodiments of the present invention are described below with reference to the accompanying drawings.

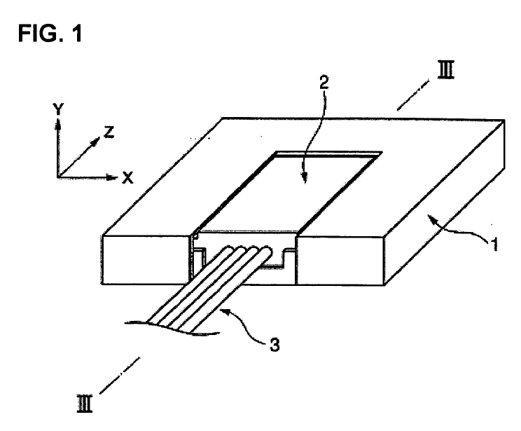

FIG. 1 is a view (perspective view) for describing a general structure of an optical module in accordance with an embodiment. As shown in FIG. 1, by providing a plug 2 at an end section of an optical fiber (optical transmission medium) 3 and attaching the plug 2 to a receptacle 1, the optical module in accordance with the present embodiment achieves an optical coupling between the optical fiber 3 and an optical element to thereby perform optical communications.

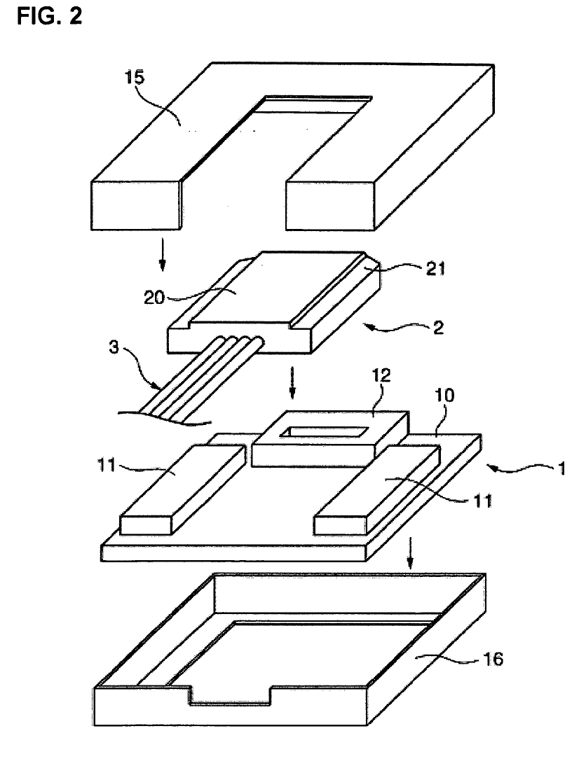

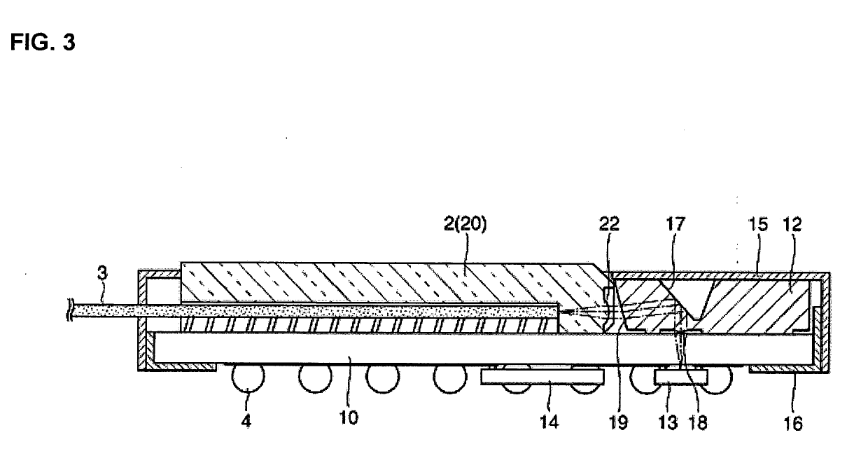

FIG. 2 is an exploded perspective view of the optical module shown in FIG. 1. FIG. 3 is a cross-sectional view of the optical module shown in FIG. 1 taken along lines III-III. The structure of the optical module in accordance with the present embodiment is described below in detail with reference to these drawings.

The plug 2 is provided at one end side of the optical fiber 3 in a manner to pinch the fiber core therein, and includes a protruded section 20, cut sections 21 that are disposed on both sides of the protruded section 20 and function as a positioning guide, and a lens 22. The plug 2 may be formed from, for example plastic material or the like.

The protruded section 20 extends near the center along the longitudinal direction (Z direction indicated in FIG. 1) of the optical fiber 3. The plug 2 in accordance with the present embodiment is formed in a manner to support one end of the optical fiber 3 within its thickness range including the protruded section 20.

The cut sections 21 are provided on both sides of the protruded section 20, respectively, and used for positioning the plug 2 in its thickness direction (Y direction indicated in FIG. 1). More concretely, as shown in FIG. 2, the cut sections 21 have upward surfaces, and the upward surfaces abut against an upper housing member 15 (to be described in detail) of the receptacle 1, whereby the plug 2 is positioned in the Y direction.

The lens 22 is provided on the side of a tip of the plug 2, and serves to change an optical signal outputted from the optical fiber 3 to generally parallel light and lead the light to an inclined surface 17 (to be described in greater detail below), or to focus an optical signal, which is emitted from the optical element 13, changed in its traveling path by a reflection surface 17 and outputted from the inclined surface 17, to an end face of the optical fiber 3. The plug 2 is provided with a surface at a position corresponding to the focal point of the lens 22 for abutting the end face of the optical fiber 3, and a plurality of V grooves (V groove array) formed toward the rear end side of the abutting surface. The optical fiber 3 is laid along the V grooves and fixed and bonded thereto, whereby the end face of the optical fiber 3 is positioned. It is noted that, if necessary, the optical fiber 3 may be pressed by a fiber covering plate, and bonded. It is noted that the lens 22 corresponds to a “first lens” in accordance with the present embodiment.

The receptacle 1 includes a substrate 10, guide blocks 11, an optical block 12, the optical element 13, a circuit chip 14, the upper housing member 15, and a lower housing member 16.

The substrate 10 has an upper surface that is generally in parallel with an optical axis of the optical module 3 and a lower surface that is generally in parallel with the upper surface, and the plug 2 is mounted on the upper surface. The plug 2 is positioned in its thickness direction (Y direction) by the upper surface of the substrate 10 and the upper housing member 15. Also, the substrate 10 supports the guide blocks 11 and the optical block 12 placed on the upper surface thereof. The substrate 10 is formed from a transparent member, such as, for example, glass, plastic material or the like. In accordance with the present embodiment, the optical element 13 is disposed on the lower surface, and the optical fiber 3 and the optical block 12 are disposed on the upper surface, wherein optical signals are transmitted and received between the optical element 13 and the optical fiber 3 through the substrate 10.

The guide blocks 11 are provided on one surface side of the substrate 10, and abut against side sections of the plug 2 to function to position the plug 2 in its width direction (X direction indicated in FIG. 1), in other words, in a direction orthogonal to the thickness direction of the plug 2 and the longitudinal direction of the optical fiber 3, respectively. The guide blocks 11 may preferably be composed of a material that has a coefficient of thermal expansion generally equal to or similar to that of the substrate 10, and also achieves good adhesion with the substrate 10. Such conditions can be realized by, for example, forming the guide blocks 11 with the same material as the constituting material of the substrate 10.

The optical block 12 is composed of a transparent material, and at least a portion thereof (in the present example, a portion of an upper side of an inclined surface 19) abuts against the tip section of the plug 2 to thereby function to position the plug 2 in the optical axis direction (Z direction indicated in FIG. 1) of the optical fiber 3. Also, the optical block 12 is placed between the optical fiber 3 and the optical element 13, and has a function to couple their optical axes to each other. The optical block 12 has an inclined surface 19 disposed in a state of being angled (i.e., a state of being neither orthogonal nor parallel) with respect to the optical axis of the optical fiber 3. More concretely, in the present embodiment, as the optical axis of the optical fiber 3 is in a state of being parallel with an XZ plane, the inclined surface 19 is arranged such that the angle between the inclined surface 19 and a plane (an XY plane) that is orthogonal to the optical axis of the optical fiber 3 is an acute angle.

The inclined surface 19 is formed on the optical block 12 at a predetermined position on the side where it abuts against the optical fiber 3. The inclined surface 19 is arranged in a state of being angled with respect to the optical axis of the optical fiber 3 as described above, in other words, is arranged in a state of diagonally traversing the optical axis of the optical fiber 3.

Because the inclined surface 19 is provided, when an optical signal outputted from the optical fiber 3 is incident upon the inclined surface 19, an incidence of returning light, which is caused by reflection of a portion of the optical signal, upon the optical fiber 3 can be avoided. Similarly, when an optical signal transmitted from the optical element 13 is reflected by the reflection surface 17 and is incident upon the inclined surface 19, an incidence of returning light caused by reflection of a portion of the optical signal upon the optical element 13 can be avoided.

Furthermore, when an optical signal is assumed to enter from the side of the optical fiber 3, the inclined surface 19 is arranged in a direction to refract the optical signal to the upper side of the optical block 12, in other words, in the present exemplary embodiment, in a direction in which the optical signal is refracted gradually away from the upper surface of the substrate 10. By this, the thickness of the optical block 12 can be made smaller while maintaining the forming accuracy.

The optical element 13 is disposed on the other surface side of the substrate 10, is electrically connected to an electrical wiring formed on the other surface of the substrate 10, and transmits an optical signal according to a drive signal applied through the electrical wiring from the circuit chip 14 or outputs an electrical signal according to the intensity of an optical signal received. The optical element 13 of the present embodiment is disposed on a lower surface side of the optical block 12 (in the present example, a lower surface side of the substrate 10) in a state in which its optical axis is generally orthogonal to the optical axis of the optical fiber 3. It is noted that the optical element 13 can be disposed on an upper surface side of the substrate 10, or may be disposed directly on the lower surface side of the optical block 12.

It is noted here that concrete examples of the optical element 13 may differ depending on whether the optical module is used on a data transmission side or on a data receiving side. When the optical module is used on the data transmission side, a light-emitting element such as a VCSEL (surface-emitting laser) is used as the optical element 13. When the optical module is used on the data receiving side, a light receiving element such as a photodiode is used as the optical element 13. Also, as illustrated as an example in FIG. 3, the electrical wiring on the other surface of the substrate 10 is electrically connected to another circuit substrate (a mother board) or the like through solder balls 4. In other words, in the present embodiment, a BGA (ball grid array) package is used as a mounting method. However, the mounting method is not limited to this method.

The circuit chip 14 is disposed on the other surface side of the substrate 10, and is electrically connected to the electrical wiring formed on the other surface of the substrate 10. When the optical element 13 is a light-emitting element, an element that includes a driver for supplying driving signals to the optical element 13 may be used as the circuit chip 14. When the optical element 13 is a light receiving element, an element that includes a receiver amplifier for amplifying output signals from the optical element 13 may be used as the circuit chip 14.

The upper housing member 15 together with the lower housing member 16 houses components of the receptacle 1, and has an opening that exposes the protruded section 20 of the plug 2. When the upper housing member 15 is fixed to the lower housing member 16, an edge section of the opening and its neighboring area abut against the cut sections 21 of the plug 2, whereby the function to position the plug 2 in its thickness direction (Y direction) is achieved. Also, the upper housing member 15 in accordance with the present embodiment is formed with an elastic plate member (for example, a metal plate spring or the like), and it is formed such that the edge section of the opening and its neighboring area of the upper housing member 15 cover the cut sections 21, when the respective members are assembled. In this instance, the elastic force of the upper housing member 15 causes a force (a pressure force) to push the plug 2 in its thickness direction, whereby the plug 2 is positioned in the Y direction.

The lower housing member 16 together with the upper housing member 15 houses the components of the receptacle 1, and has an opening that exposes the other surface of the substrate 10. A core module composed of the substrate 10, the guide blocks 11, the optical block 12 and the like is embedded in the lower housing member 16, and bonded thereto with adhesive, solder or the like. Normally, the assembly is conducted in the following manner: the core module in a stage in which it is attached to the lower housing member 16 is mounted on a mother board or the like, then the plug 2 is inserted inside guide surfaces of the guide blocks 11 and the optical block 12, and then the upper housing member 15 is placed thereon.

The reflection section 17 has a function to bend a traveling path extending from the inclined surface 19 through the optical block 12 and reaching the optical element 13 toward the side of the substrate 10. An optical signal entering from one end of the optical fiber 3 is refracted by the inclined surface 19 and propagates within the optical block 12, and then the optical signal is changed in its optical path by the reflection surface 17 and led through the substrate 10 to the optical element 13. Alternatively, an optical signal outputted from the optical element 13 passes through the substrate 10 and the optical block 12, and is changed in its optical path by the reflection surface 17 and led to the inclined surface 19. In the present embodiment, as shown in FIG. 3, the reflection surface 17 is formed by cutting a portion of the optical block 12 to define a surface having an inclination slightly smaller than about 45 degrees with respect to the XZ plane, and is formed in one piece with the optical block 12. Also, by forming the optical block 12 with a transparent material, an optical signal is passed through the optical block 12, and reflected by the reflection surface 17. The reflection surface 17 can be realized through, for example, selecting an appropriate material that composes the optical block 12 to thereby set a refractive index difference between the optical block 12 and its surrounding gas (air or the like) to a condition in which incident light has a total reflection (or a condition approximate thereto). Also, when such a total reflection condition is difficult to be met, the reflection surface 17 may be realized by providing a reflection film such as a metal film on the outside of the optical block 12.

The lens 18 is disposed on a traveling path of an optical signal between the reflection section 17 and the optical element 13, and changes the optical signal outputted from the optical element 13 to generally parallel light to be led to the reflection surface 17. Alternatively, the lens 18 focuses an optical signal, which is outputted from an end face of the optical fiber 3, reflected by the reflection surface 17, and advances toward the optical element 13, to a predetermined position (at a light emission section or a light receiving section) of the optical element 13. In the present embodiment, the lens 18 is provided in one piece with the optical block 12 at one surface side of the optical block 12. More concretely, a concave section is provided at a predetermined position in the optical block 12, and the lens 18 is formed inside the concave section. It is noted that the lens 18 corresponds to a “second lens” in the present embodiment.

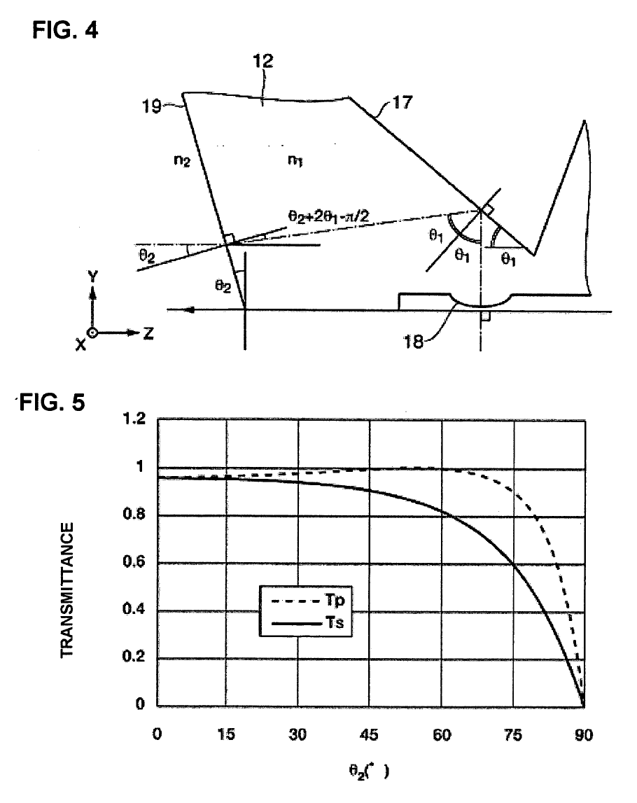

FIG. 4 is a diagram for describing a method of analytically obtaining inclinations of a reflection surface and an inclined surface. In FIG. 4, an area adjacent to the inclined surface 19 and the reflection surface 17 of the optical block 12 is shown enlarged. It is noted that hatching is omitted for convenience of explanation. It is noted here that, as a prerequisite of the example shown in FIG. 4, (1) principal ray of an optical signal incident upon the lens 18 is in parallel with the Y axis, and coincides with the optical axis of the lens 18, and (2) principal ray of an optical signal propagating from the inclined surface 19 toward the optical fiber 3 is in parallel with the Z axis, and coincides with the optical axis of the optical fiber 3 and the optical axis of the lens 22. Also, an angle between the reflection surface 17 and a XZ plane is defined as an inclination θ₁ of the reflection surface 17, and an angle between the inclined surface 19 and a XY plane is defined as an inclination θ₂ of the inclined surface 19. In this case, as shown in the figure, the inclination θ₂ is equal to an angle defined between the principal ray of the optical signal outputted from the optical fiber 3 and the inclined surface 19. Also as shown in the figure, the inclination θ₁ is equal to an angle of incidence and an angle of reflection of the principal ray of the optical signal with respect to the reflection surface 17. Also, a refractive index of the optical block 12 is n₁, and a refractive index of its surrounding material is n₂. In the present example, a medium that is present around the optical block 12 is air whose refractive index n₂ is about 1.0.

FIG. 5 is graph for describing a preferred example of conditions for setting the inclination θ₂ of the inclined surface 19. FIG. 5 is a graph showing the relation between the inclination θ₂ of the inclined surface 19 and the transmittance of light incident upon the inclined surface 19. In the illustrated example, transmittance characteristics are calculated on condition that the refractive index n₁ of the optical block 12 is 1.53, and the refractive index n₂ of the surrounding medium (air) is 1.0. A dotted line in the figure indicates transmittance characteristics of a component (p polarization) Tp whose direction of vibration is in parallel with a plane of incidence, and a solid line in the figure indicates transmittance characteristics of a component (s polarization) Ts whose direction of vibration is perpendicular to the plane of incidence. As shown in the figure, when the inclination θ₂ is too large, the polarization dependence of the transmittance characteristics becomes greater. In other words, the difference in transmittance depending on the directions of vibration of an optical signal becomes greater. Accordingly, the inclination θ₂ may preferably be set between about 15° and about 30°, and more preferably be set to about 20° under the conditions of the present example depending on the values of refractive indexes n₁ and n₂.

When the inclination θ₂ of the inclined surface 19 is decided, the inclination θ₁ of the reflection surface 17 can be uniquely obtained by the following formula:

$${θ}_{1} = \frac{1}{2} \{ {sin}^{- 1} ( \frac{{n}_{2}}{{n}_{1}} sin {θ}_{2} ) - {θ}_{2} + \frac{π}{2} \} \qquad [ Formula 1 ]$$

However, when the action of total reflection is used at the reflection surface 19, the total reflection condition defined by the following formula needs to be satisfied. When it is difficult to satisfy the total reflection condition, a reflection film such as a metal film may need to be additionally provided on the outside of the reflection surface 19.

$${θ}_{1} > {sin}^{- 1} ( \frac{{n}_{2}}{{n}_{1}} ) \qquad [ Formula 2 ]$$

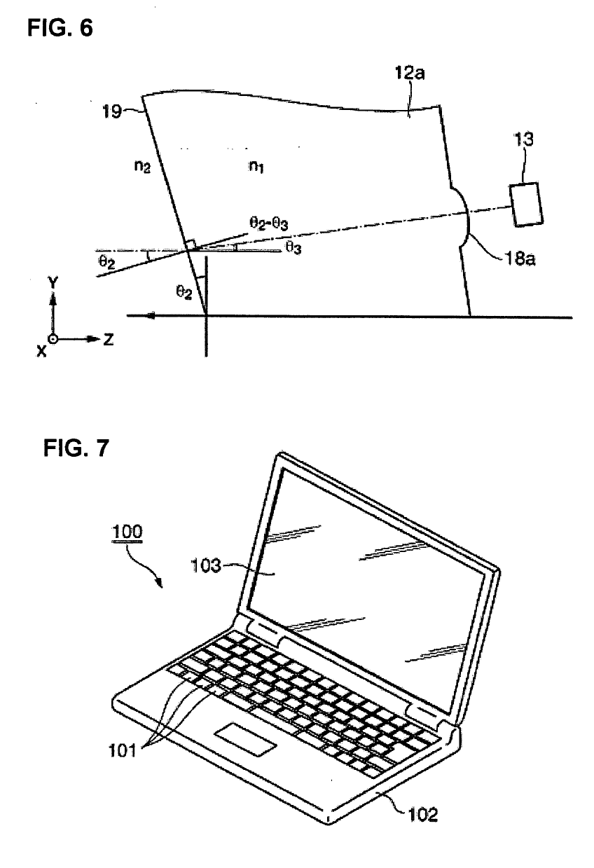

FIG. 6 is a diagram for describing a method of analytically obtaining an inclination of the inclined surface 19 of an optical module having another exemplary structure. As shown in FIG. 6, the optical module may be formed without providing a reflection surface in an optical path between an inclined surface 19 and an optical element 13. In this case, an optical signal, which is outputted from an optical fiber 3 and changed by a first lens (illustration omitted) into generally parallel light, is refracted by the inclined surface 19, passing through an optical block 12a, focused by a lens (second lens) 18a, and is transmitted to the optical element 13. Also, an optical signal emitted from the optical element is changed by the lens 18a into generally parallel light, passing through the optical block 12a, incident upon the inclined surface 19, refracted by the inclined surface 19, then focused by the first lens 1, and transmitted to the optical fiber 3. In this case, the inclination θ₂ of the inclined surface 19 is set by the method described above, for example, to about 20°. As the inclination θ₂ is decided, an inclination θ₃ indicating the orientation of refraction of an optical signal can be uniquely obtained by the following formula, according to the relation between the refractive index n₁ of the optical block 12a and the refractive index n₂ of the surrounding medium.

$${θ}_{1} = {θ}_{2} - {sin}^{- 1} ( \frac{{n}_{2}}{{n}_{1}} sin {θ}_{2} ) \qquad [ Formula 3 ]$$

Accordingly, the optical element 13 is disposed in a manner that the optical axis of the optical element 13 coincides with the orientation of refraction indicated by the inclination θ₃.

According to the present embodiment, the optical transmission medium and the optical element are optically coupled to each other through the inclined surface that is in a state of not being orthogonal with respect to the principal ray of an optical signal. Therefore, even when returning light (reflected wave component) is generated at the inclined surface, the returning light advances in a direction different from the direction of the principal ray of the optical signal. Accordingly, an incidence of the returning light upon the optical element or the optical transmission medium can be avoided, and noise caused by returning light can be reduced.

The optical modules in accordance with the embodiments described above can be implemented and used in structures, such as, optical communications devices (optical transceivers), photoelectric mix mounted circuit substrates, and the like.

FIG. 7 is a perspective view of an exemplary electronic apparatus equipped with one of the optical modules in accordance with present embodiments. FIG. 7 shows a personal computer as an example of an electronic apparatus. A notebook type personal computer 100 shown in FIG. 7 is equipped with a main body section 102 having a keyboard 101, and a display panel 103. The optical module in accordance with the present embodiment is included in the main body section 102 of the personal computer 100 shown in FIG. 7, and used for performing data communications between the personal computer 100 and external devices. Furthermore, the optical module in accordance with the present embodiment may also be used for performing data communications between units within the main body section 102 of the personal computer 100 (for example, between the disk device and the mother board).

It is noted that the invention is not limited to the contents of the embodiments described above, and various changes can be made within the scope of the subject matter of the invention.

For example, in the embodiments described above, the inclined surface 19 is formed in an orientation angled (downward) to oppose to a first surface of the substrate 10. However, in contrast, it can be formed in an orientation angled not to oppose (upward) to the first surface.

Also, in the embodiments described above, the reflection surface 17 and the lens 18 are formed in one piece with the optical block 12. However, the reflection surface 17 and the lens 18 can be provided as separate components. Similarly, the lens 22 may not be formed in one piece with the plug 2.

Moreover, in the embodiments described above, an optical fiber is referred to as an example of the optical transmission medium. However, without being limited to these embodiments, an optical waveguide or the like may be used as the optical transmission medium.

What is claimed is:

1. An optical module adapted to be attached to one end of an optical transmission medium to achieve optical communications through the optical transmission medium, the optical module comprising:
an optical element that transmits or receives an optical signal; and
an optical block that is disposed in a transmission path of the optical signal and couples the optical axes of the optical element and,
wherein the optical block has an inclined surface the normal of which forms an angle with respect to the optical axis of the optical transmission medium, the angle being in a range of greater than 0 degree to less than 90 degree or in the range of greater than 90 degree to less than 180 degree.

2. An optical module according to claim 1, wherein the optical block is disposed such that a gap exists between the inclined surface and the optical transmission medium.

3. An optical module according to claim 1, wherein the optical element is disposed to receive the optical signal from the optical transmission medium after the optical signal is refracted at the inclined surface, or to transmit the optical signal to the inclined surface where the optical signal is refracted toward the optical transmission medium.

4. An optical module according to claim 1,
wherein the optical block has a second lens that changes the optical signal emitted from the optical element into generally parallel light, or focuses the optical signal advancing toward the optical element at a predetermined position relative to the optical element.

5. An optical module according to claim 1, wherein the optical element is disposed on or in proximity to a side of the optical block in a state in which the optical axis of the optical element is generally orthogonal to the optical axis of the optical transmission medium, and the optical block further equipped with a reflection surface that changes a course of the optical signal that is outputted from the optical transmission medium and reflected at the inclined surface toward the optical element, or reflects the optical signal transmitted from the optical element toward the inclined surface.

6. An optical module according to claim 1, wherein the angle formed by the normal of the inclined surface with respect to the optical axis of the optical transmission medium is such that the optical signal from the optical transmission medium in refracted to an upper side of the optical block.

7. An optical module according to claim 1, wherein the angle of the normal of the inclined surface with respect to the optical axis of the optical transmission medium is between about 15° and about 30°.

8. An optical module according to claim 1, wherein the inclined surface is disposed such that at least a portion of the inclined surface contacts a tip section of the plug that supports the optical transmission medium.

9. An optical module according to claim 5, wherein the angle of the normal of the inclined surface with the optical axis of the optical transmission is smaller an angle of reflection of the refection surface.

10. An electronic device comprising the optical module according to claim 1.

11. A portable digital assistant device comprising the optical module according to claim 1.

12. An optical module adapted to be attached to one end of an optical transmission medium, the optical module comprising:
a substrate;
an optical element that is disposed on one side of the substrate and transmits or receives an optical signal; and
an optical block that is disposed on another side of the substrate, is disposed in an optical path of the optical signal, and has an inclined surface that is neither perpendicular nor parallel to the optical axis of the optical transmission medium.
